(19) United States
(12) Patent Application Publication
(10) Pub. No.: US 2025/0368555 A1
(43) Pub. Date: Dec. 4, 2025

(54) Microbial Battery Membrane Bioreactor

(71) Applicant: The Board of Trustees of the Leland Stanford Junior University, Stanford, CA (US)

(72) Inventors: Chungheon Shin, Los Altos, CA (US); Craig S. Criddle, San Luis Obispo, CA (US); Sebastien Tilmans, San Francisco, CA (US)

(21) Appl. No.: 18/707,710

(22) PCT Filed: Dec. 22, 2022
(86) PCT No.: PCT/US2022/053800

§ 371 Date: May 6, 2024

Related U.S. Application Data
(60) Provisional application No. 63/293,990, filed on Dec. 27, 2021.

(51) Int. Cl. C02F 3/00; C02F 3/12; H01M 4/02; H01M 8/16

(52) U.S. Cl. CPC C02F 3/005; C02F 3/1273; H01M 4/02; H01M 8/16; C02F 2203/006; C02F 2303/20; H01M 2004/027; H01M 2004/028

(57) ABSTRACT

A microbial battery membrane bioreactor for wastewater treatment and energy production has a microbial battery [302] coupled with a membrane module [304]. Bioanodes [318] coated with exoelectrogen are in a fixed submerged position while solid-state cathodes [320] are movable between a submerged position where they are positioned close to the bioanodes and a raised position above the solution where they are exposed to air for regeneration. In the submerged position. exoelectrogens on bioanodes [318] oxidize organic matter, generating reducing power and creating electron flow to cathodes [320]. This flow of electrons from a bioanode into a cathode enables direct electric energy recovery by connecting a load to the electrodes.

### FIELD OF THE INVENTION

The present invention relates generally to methods and systems for wastewater treatment using bioreactors. More specifically, it relates to techniques for bioelectrochemical energy recovery from wastewater using a microbial battery.

### BACKGROUND OF THE INVENTION

Conventional domestic wastewater treatment traditionally relies upon aerobic treatment systems, consuming ˜0.6 kWh per m³ of treated wastewater. The majority of the energy consumption, ˜50%, is due to oxygen delivery for aerobic heterotrophic bacteria that oxidize organic matter in domestic wastewater.

Organic matter in domestic wastewater can be utilized as a renewable energy source because it has reducing power that can drive energy production. Bioelectrochemical systems can recover energy from wastewater while producing clean water, potentially offsetting the current high energy requirement for wastewater treatment using conventional aerobic processes. Bioelectrochemical systems incorporate a bioanode in which exoelectrogens oxidize organic matter, generating reducing power and creating electron flow to a cathode. This flow of electrons from a bioanode into a cathode enables direct electric energy recovery.

Among bioelectrochemical systems, microbial fuel cells have been widely studied since the 1990s. As illustrated in FIG. 1, a microbial fuel cell includes a bioanode chamber 100 where oxidation takes place and a cathode chamber 102 where reduction takes place. The bioanode chamber 100 contains a bioanode 106 coated with exoelectrogen 108, and the cathode chamber 102 contains a cathode 110. The two chambers are partitioned by a proton exchange membrane 104. In the bioanode chamber 100, exoelectrogens 108 oxidize organic matter to CO₂ (producing electrons and protons), and the electrons migrate to the cathode where O₂ is reduced to H₂O. Simultaneously, protons from the bioanode 106 diffuse through proton exchange membrane 104 and participate in the reduction taking place at the cathode 110. The proton exchange membrane 104 also serves as a barrier to prevent diffusion of O₂ from the cathode chamber 102 into the bioanode chamber 100.

Conventional microbial fuel cells have several problems that prevent practical commercial implementation. The oxygen diffusion limitation 112 from air into the cathode chamber 102 and the proton (H⁺) diffusion limitation 114 from the bioanode 106 to the cathode 110 through a proton exchange membrane 104 result in inefficient operation of the microbial fuel cell, especially at larger scale where cation diffusion lengths become excessive. In addition, dissolved oxygen can enter the bioanode chamber 100 where it can stimulate aerobic growth of heterotrophic bacteria, short-circuiting electron flow.

The microbial battery disclosed in U.S. Pat. No. 9,509,028 is an alternative technology that can avoid the above limitations of microbial fuel cells. As shown in FIG. 2, the microbial battery has a bioanode 200 with exoelectrogen coating 202 and a cathode 204, but in contrast with the microbial fuel cell, the two electrodes are in the same chamber 206 (i.e., there is no proton exchange membrane separating two chambers from each other) and the cathode 204 is a solid-state cathode that can be repeatedly oxidized by moving it into the air for regeneration. This design avoids the need for O₂ inside the chamber 206, thereby avoiding the need for cation exchange membranes.

This conventional microbial battery design, however, is not sufficient for many real-world applications because there is no currently existing design and/or method that enables continuous operation at large scale. There is also a need to enable oxidation and reduction 208 of the cathode 204 for continuous operation while avoiding rate-limitations of slow cation (e.g., proton) diffusion 210 from the bioanode 200 to the cathode 204. There is also a need to avoid of having rate-limitations of hydrolysis 212 of particulate organic matter in wastewater.

### SUMMARY OF THE INVENTION

To address the above problems in current technology, we disclose a microbial battery membrane bioreactor and method that enables more efficient biodegradation of particulate organic matter and more rapid cation migration from the bioanodes to the cathodes. This design can facilitate hydrolysis of complex particulate organic matter to simpler soluble substrates for exoelectrogens within the bioanode and can also accelerate diffusion of cation to the cathode, thereby increasing energy recovery while also generating a high-quality effluent. These advantages are achieved by coupling a membrane module to a microbial battery, and providing the microbial battery with movable cathodes that allow the cathodes to be located close to the bioanodes and alternately submerged and exposed to air during operation. In contrast, conventional bioelectrochemical systems have electrodes that are fixed in position.

In a microbial battery membrane bioreactor according to embodiments of the invention, bioanodes oxidize reduced soluble compounds, releasing electrons to solid-state cathodes, which are intermittently oxidized by exposure to oxygen in the air.

A membrane module facilitates retention and hydrolysis of colloidal and particulate organic matter, producing reduced soluble compounds that functions as electron donors for exoelectrogens. An electrolyte and influent containing one or more reduced compounds enters the microbial battery, is circulated between the microbial battery and membrane module, and an effluent exits from the membrane modules. Exoelectrogenic microorganisms are attached to immobile bioanodes and oxidize soluble electron donors, creating a voltage gradient that drives electron flow through external circuits together with simultaneous diffusion of electrolyte cations. Cathodes are vertically movable between a first position in which the cathodes are fully immersed and a second position in which the cathodes are lifted out of the electrolyte and fully exposed to oxygen in the atmosphere. The spacing between bioanodes and immersed cathodes is less than 5 cm when the cathodes are immersed. The bioanodes and cathodes may be paired parallel plates. In other embodiments, they may be rods, fibers, fibers with attached rods, a conductive mesh, or a sponge structure with conductive current collectors. The rods may have a cross-section with various shapes including circular, rectangular, triangular, or hexagonal cross-sectional shape. In contrast with conventional microbial fuel cells, the cathodes and the bioanodes are not separated by a proton-exchange membrane. The bioanodes may be composed of graphene or conductive activated carbon-based materials. The cathodes may be composed of Prussian Blue attached to a conductive structure or a second conductive material enabling cation diffusion into and out of the electrode. The membrane module may include hollow fiber ultrafiltration membranes with membrane pore diameters in the range 0.01 to 0.07 μm. The membrane module may also include gas-diffusers for fouling control and mixing. The membrane bioreactor may be spatially separated from the microbial battery to prevent short-circuiting of fluid flow around the cathodes and bioanodes or incidental delivery of oxygen to the bioanode. A recirculation pump may be used to move bulk electrolyte from the membrane bioreactor to the microbial battery, providing additional contact time for hydrolysis of complex organic matter. A distributor may be connected to the recirculation pump and positioned below the cathodes and bioanodes to enhance hydrolysis and provide even distribution of complex organic matter. The membrane module includes an outlet that controls the concentration of the hydrolysate that circulates through the microbial battery for energy production. The bioreactor may be followed by post treatment (e.g., a primary clarifier, microscreen) to increase the loading rate of soluble electron donors. The system may be configured to maintain and control a stable liquid level that may be constant or repeating.

In one aspect, the invention provides a method for bioelectrochemical wastewater treatment comprising: injecting wastewater into a microbial battery comprising bioanodes and cathodes, wherein the bioanodes are coated with exoelectrogen and wherein the cathodes are solid state cathodes; circulating the wastewater between the microbial battery and a membrane module that retains particulate organic matter; periodically moving the cathodes vertically between a first position and a second position, wherein the cathodes in the first position are entirely above a surface level of the wastewater and are oxidized by exposure to oxygen in air; wherein the cathodes in the second position are submerged entirely below the surface level of the wastewater and oxidize soluble compounds in the wastewater, releasing electrons to the cathodes; wherein the cathodes in the second position have less than 5 cm separation from the bioanodes; and recovering treated effluent from the membrane module.

The cathodes in the first position may be entirely above a surface level of the wastewater, and the cathodes in the second position may be submerged entirely below the surface level of the wastewater.

The method may further include performing fouling control of membranes in the membrane module using gas-diffusers. The method may further include performing hydrolysis facilitating even distribution of complex organic matter using a distributor positioned below the cathodes and bioanodes. The method may further include performing post treatment to the treated effluent using a primary clarifier or microscreen.

In another aspect, the invention provides a microbial battery membrane bioreactor comprising: a reactor chamber adapted to hold wastewater at a liquid level; a wastewater inlet to the reactor chamber; a membrane module positioned within the reactor chamber below the liquid level and adapted to provide ultrafiltration of the wastewater; an effluent outlet from the membrane module; a collection of bioanodes fixed in a position within the reactor chamber below the liquid level; a collection of cathodes vertically movable between a first position within the reactor chamber below the liquid level and a second position above the liquid level; wherein the bioanodes and cathodes are paired with a bioanode-cathode surface separation less than 5 cm when the cathodes are in the first position; and a motor adapted to move the cathodes vertically. The bioreactor may be configured to maintain and control the liquid level at a constant level.

The bioanodes and cathodes may comprise paired parallel plates. The motor may be adapted to rotate the paired parallel plates of the cathodes, or may be adapted to raise and lower the paired parallel plates of the cathodes linearly. The cathodes may be arranged to move vertically together in a single set. The cathodes may be divided into two or more sets, wherein the sets are configured to move vertically in opposite directions.

The cathodes and the bioanodes are preferably not separated by any membrane in the reactor chamber and preferably are not separated by any proton-exchange membrane.

The bioanodes may comprise rods, fibers, fibers with attached rods, or a conductive mesh. Similarly, the cathodes may comprise rods, fibers, fibers with attached rods, or a conductive mesh. The rods of the bioanodes or cathodes may have a circular, rectangular, triangular, or hexagonal cross-sectional shape.

The bioanodes may be composed of graphene or conductive activated carbon-based materials. The cathodes may be composed of Prussian Blue attached to a conductive structure or a second conductive material enabling cation diffusion into and out of the electrode.

The membrane module preferably comprises hollow fiber ultrafiltration membranes with membrane pore diameters in the range 0.01 to 0.07 μm. The membrane module may incorporate gas diffusers.

The membrane module is preferably separated from the cathodes and bioanodes by a physical wall adapted to prevent short-circuiting of fluid flow around the cathodes and bioanodes or incidental delivery of oxygen to the bioanode. The microbial battery membrane bioreactor preferably includes a recirculation pump adapted to send bulk solution through the physical wall, providing more contact time for hydrolysis of complex organic matter. The microbial battery membrane bioreactor may include a distributor connected to the recirculation pump and positioned below the cathodes and bioanodes to enable even distribution of complex organic matter. The membrane module may include a wasting outlet to control solids residence time within the reactor.

### BRIEF DESCRIPTION OF THE DRAWINGS

FIG. 1 is a schematic diagram of a conventional microbial fuel cell.

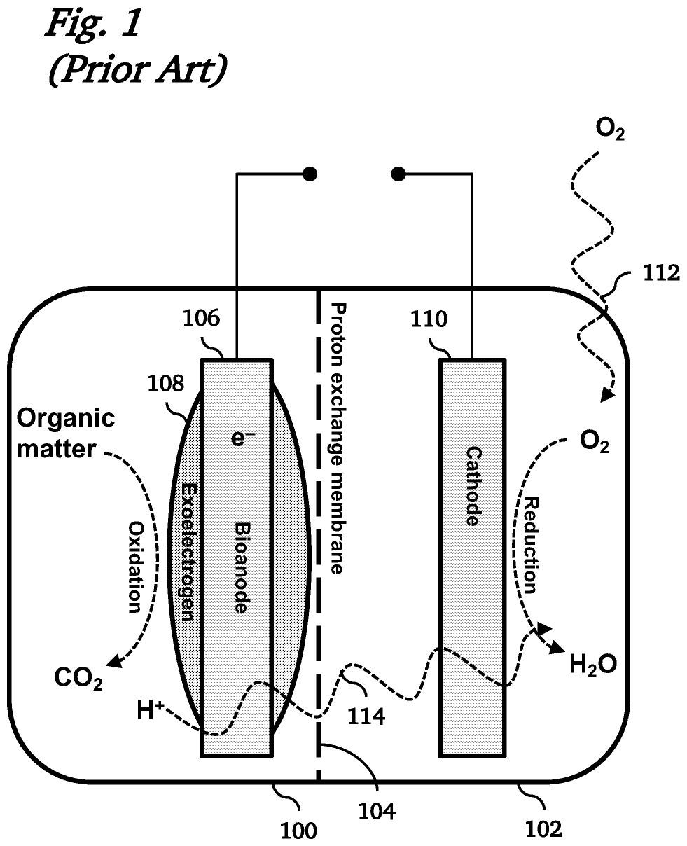

FIG. 2 is a schematic diagram of a conventional microbial battery.

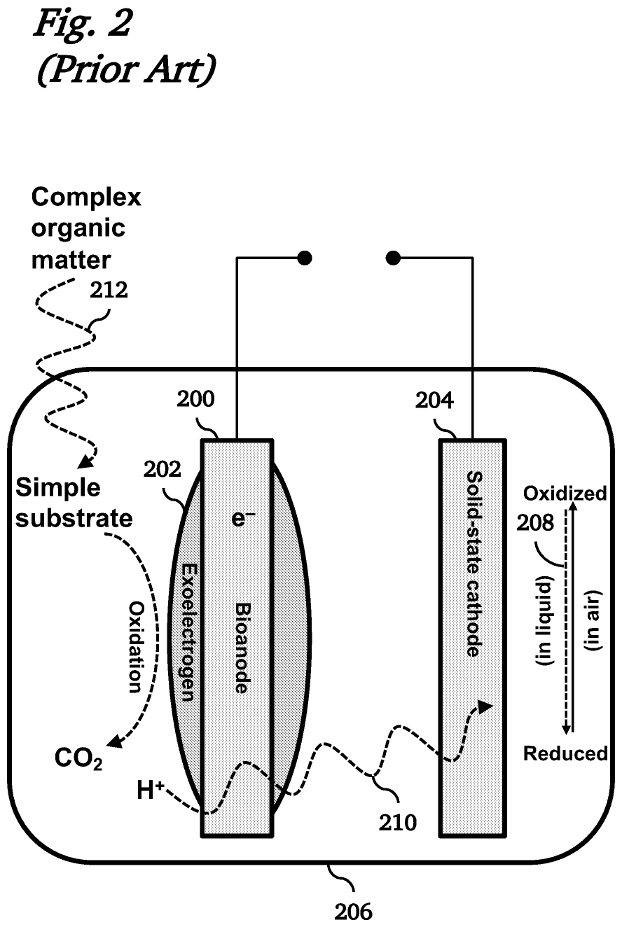

FIG. 3 is a schematic diagram of a microbial battery membrane bioreactor, according to an embodiment of the invention.

FIG. 4A and FIG. 4B are schematic diagrams illustrating two phases of operation of the microbial battery compartment of FIG. 3 showing, respectively, cathodes submerged in a lowered position and exposed to air in a raised position.

FIG. 5A and FIG. 5B are schematic diagrams illustrating an alternative electrode configuration of a microbial battery compartment in which there are two sets of cathodes mounted in two separately movable racks allowing half the cathodes to be positioned in air above the solution while another half is submerged in the solution.

FIG. 5C and FIG. 5D are schematic diagrams showing an alternative electrode configuration of a microbial battery compartment in which the cathodes are attached to a rod that rotates and moves the cathodes to positions above and below the surface of the solution.

FIG. 6 is a schematic diagram illustrating an alternative electrode configuration of a microbial battery compartment in which cathodes 600 are shaped as columns that move in and out of a bioanode having shafts shaped to receive the columns.

FIG. 7A is a schematic diagram illustrating an implementation in which electrodes are conductive fibers or fibers attached to and surrounding a larger central rod.

FIG. 7B is a schematic diagram illustrating an implementation in which electrodes are conductive fibers arranged in a mesh to form plate-shaped electrodes.

FIG. 8 is a schematic diagram of a microbial battery membrane bioreactor including a distributor in the microbial battery compartment.

### DETAILED DESCRIPTION

Embodiments of the present invention provide a microbial battery membrane bioreactor that allows a decoupling of solids retention time (SRT) from hydraulic retention time (HRT) so as to provide efficient hydrolysis of complex organic matter while maintaining HRT of about 5 hours, comparable to HRT values of existing secondary treatment systems. The decoupled SRT can be 3 to 20 days, providing sufficient retention time for hydrolysis of particulate organic matter, enabling accelerated biodegradation, and increasing the efficiency of COD removal and energy recovery. These advantages are achieved by coupling a membrane module to a microbial battery, and providing the microbial battery with movable cathodes. In contrast, conventional bioelectrochemical systems have electrodes that are fixed in position.

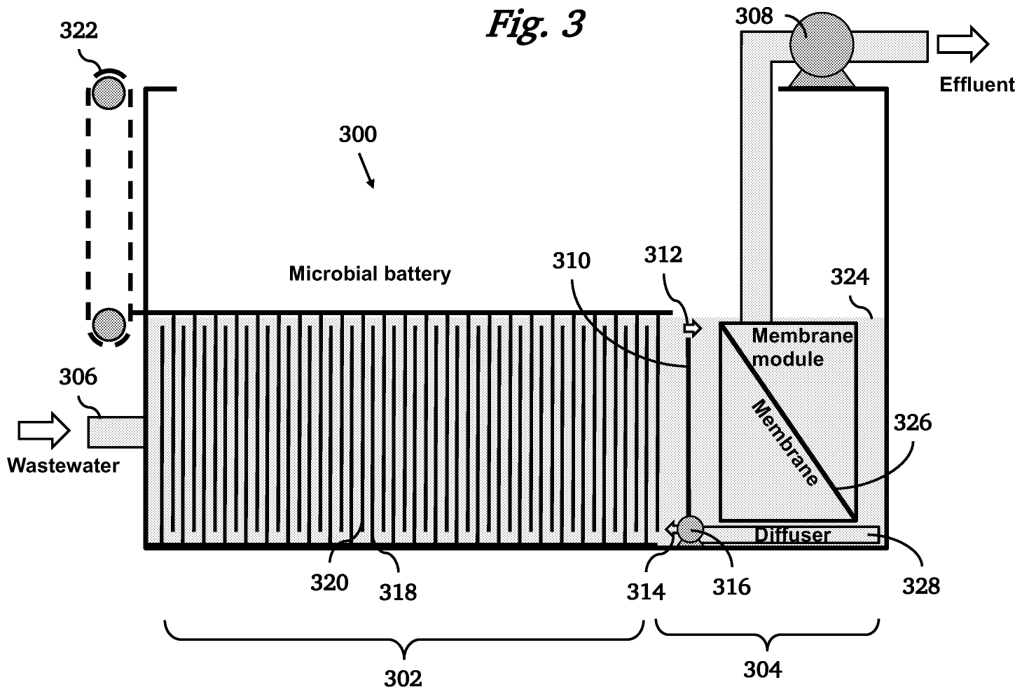

FIG. 3 illustrates a microbial battery membrane bioreactor, according to an embodiment of the invention. The bioreactor 300 has a microbial battery 302 coupled with a membrane module 304. Wastewater 306 containing complex organic matter enters the microbial battery 302 and circulates between the microbial battery 302 and membrane module 304. The treated effluent is recovered as it exits the bioreactor from the membrane module 304 via a permeate pump 308. The microbial battery 302 and membrane module 304 may be configured as two compartments of a single reactor chamber that holds the bulk solution, where a wall 310 separating the compartments has openings 312, 314 allowing circulation between the two compartments. A recirculation pump 316 is positioned at opening 314 to recirculate the bulk solution between the compartments.

The microbial battery membrane bioreactor 300 contains a microbial battery 302 having interleaved sets of bioanodes 318 and solid-state cathodes 320. The bioanodes 318 are coated with exoelectrogen and occupy fixed positions entirely submerged beneath the surface of the bulk solution. The solid-state cathodes 320 are vertically movable during operation so that they can be entirely lifted out of the bulk solution and exposed to air. In addition, the bioanodes 318 and cathodes 320 are interleaved in a sequentially paired arrangement with close proximity between adjacent bioanodes and cathodes. These two features of the electrode configuration provide advantages over other bioelectrochemical systems.

The closely spaced (preferably less than 5 cm in commercial settings), sequentially paired electrodes 318 and 320 enable short diffusion length scales for current-carrying cations (primarily protons) from the bioanode to the cathode, even in large-scale systems. Because of the short diffusion length scale for cations, the bioanodes are not diffusion-limited, enabling more efficient oxidation of soluble organic matter and hydrolysate. The less than 5 cm separation between adjacent electrodes facilitates a rapid reaction that is not limited by diffusion. The sequential pairing of electrodes in interleaved alternating bioanode-cathode pairs enables high electrode packing density per unit of reactor volume, further enhancing efficiency.

During operation, exoelectrogens on bioanodes 318 oxidize organic matter, generating reducing power and creating electron flow to cathodes 320. This flow of electrons from a bioanode into a cathode enables direct electric energy recovery by connecting a load to the electrodes.

Regeneration of the solid-state cathodes 320 is performed by removing the cathodes from the liquid and exposing them to oxygen in the air. In preferred embodiments, the cathodes 320 are arranged in a rack that is moved up and down vertically using a mechanical motor unit 322 (e.g., linear actuator) so that the cathodes can be alternatively submerged in the bulk solution 324 or exposed to air. The surface level of the bulk solution 324 preferably remains constant throughout operation.

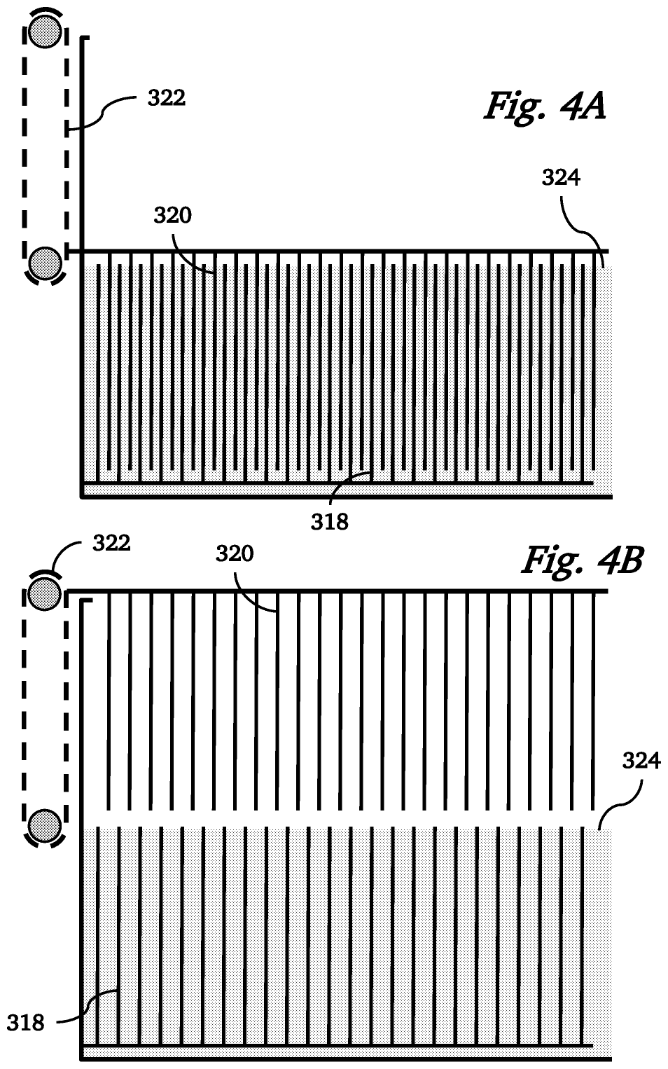

FIGS. 4A-B illustrate the microbial battery with cathodes 320 in two positions, implementing discontinuous (batch) operation. FIG. 4A shows the cathodes 320 entirely submerged below the surface level of the bulk solution (“down position”). During this phase of operation, the cathodes are in the solution positioned a short distance from the bioanodes 318, and a reduction reaction proceeds, resulting in the transfer of electrons from the bioanode as electric current. Once the cathodes are charged, the mechanical motor unit 322 raises the cathodes 320 entirely above the surface level of the bulk solution (“up position”), as shown in FIG. 4B. In this position, the cathodes 320 are exposed to oxygen-containing air, allowing time for oxidation and regeneration (preferably less than 1 hour). Because the vertically movable cathodes 320 are exposed directly to oxygen-containing air during regeneration in the up-position, oxygen delivery into the liquid phase is not required for regeneration of the cathodes while submerged, as is the case with fixed-position cathodes. This avoids growth of heterotrophic bacteria that can limit exoelectrogen activity and energy recovery. Because the cathodes are movable, the system does not need to have separate chambers for cathodes and bioanodes, unlike other bioelectrochemical systems.

The number of electrodes preferably is selected based upon reactor volume, an organic loading rate (kg-organic/m³/d) of a system, and a capacity of electrodes. For example, the microbial battery 302, packed with alternating bioanodes 318 and cathodes 320, preferably will occupy over 50% of the reactor volume, and the membrane module will have less than 50% reactor volume.

An electrode (for both bioanode and cathode) preferably has thickness on the scale of a few centimeters or less (preferably less than 1 cm) and a length on the scale of a few meters (preferably less than 2 m).

The bioanode is composed of a material that is conductive and biocompatible. For example, the bioanode may be composed of graphene or conductive activated carbon-based materials. Activated carbon-based bioanodes are preferred due to their affordable price, biocompatibility, high specific surface area, and high conductivity. The biocompatibility and high specific surface area can sustain exoelectrogen biofilms, providing mean cell residence time (MCRT) values of over 20 days that exceed the SRT for hydrolysis, guaranteeing a robust biological performance at low temperature and under upset situations (e.g., biosolids loss or a toxic input to the system).

As described in U.S. Pat. No. 9,509,028, solid state cathodes can be any material that has a solid-state composition and supports reduction and oxidation while maintaining its structural integrity. As a cationic electrode material, Prussian Blue is preferred for use as the solid-state cathode material, as described in Xie, et al. “Use of low cost and easily regenerated Prussian Blue cathodes for efficient electrical energy recovery in a microbial battery.” Energy & Environmental Science 8:546-551. Other suitable materials for the cathodes include layered oxides and polyanions.

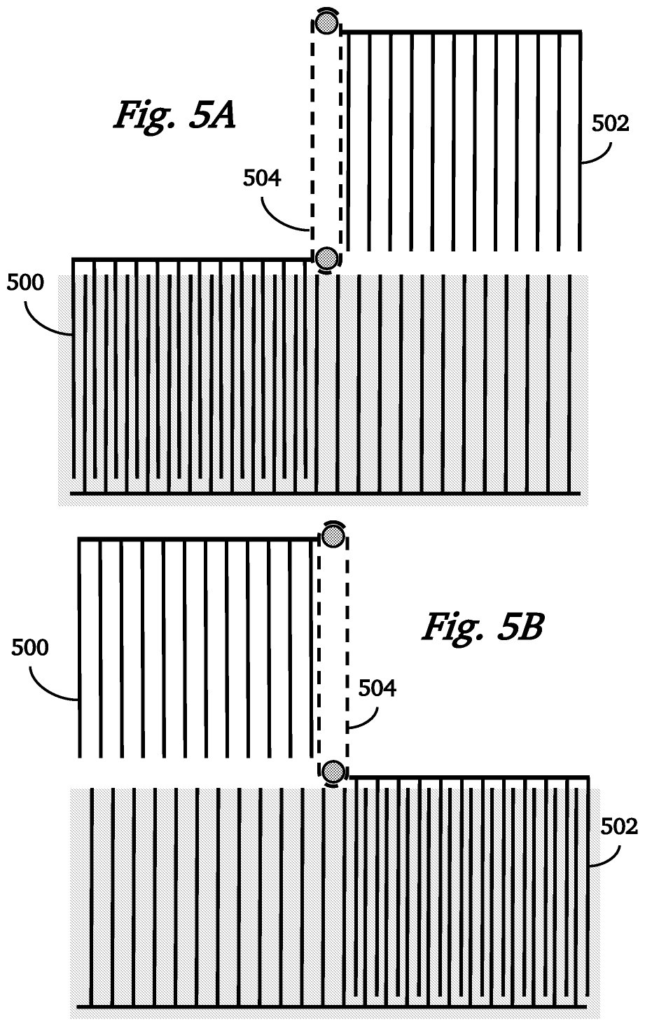

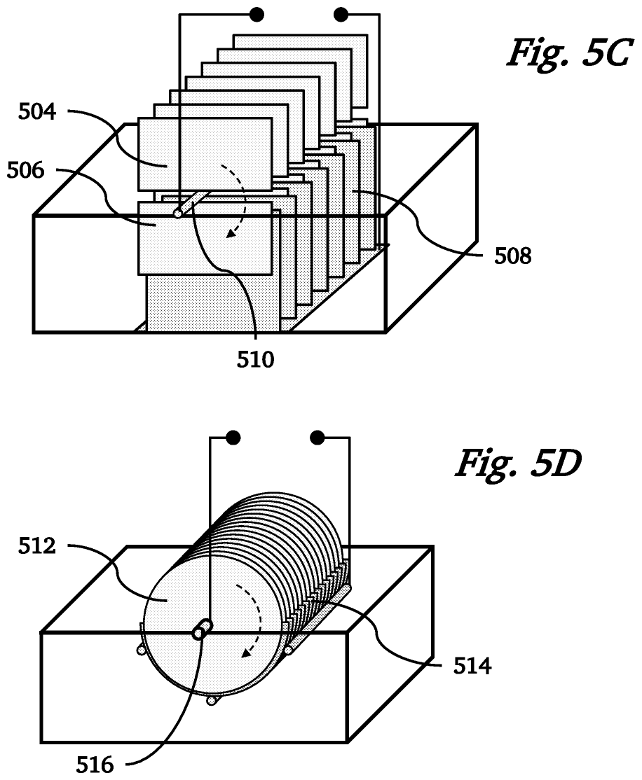

The cathodes may be divided into two or more sets to enable simultaneous reduction and oxidation with a steadier power output. FIGS. 5A-B illustrates an example of two sets of cathodes mounted in two separately movable racks 500 and 502. In one phase of operation, shown in FIG. 5A, rack 500 with half the cathodes is positioned above the solution allowing cathode regeneration by oxidation in air, while rack 502 is submerged in the solution to participate in reduction of dissolved organic matter. Periodically, the racks are both vertically moved by a mechanical motor unit 504 in opposite directions into opposite positions, reversing the roles of the two sets of cathodes. Thus, in another phase of operation, shown in FIG. 5B, rack 502 is positioned above the solution allowing half of the cathodes to regenerate in air, while rack 500 is submerged in the solution. This configuration, with one set submerged and the other set in air, provides simultaneous reduction and oxidation, and thereby enables stable and continuous operation, with a steadier power output.

Simultaneous reduction and oxidation may be implemented in various alternate configurations, as illustrated in FIG. 5C and FIG. 5D. In the configuration of FIG. 5C, the two sets of cathode plates 504 and 506 are arranged in coplanar pairs mounted on a conductive rod 510. While one cathode of each pair is in air, the other cathode of the pair is submerged. To switch from one phase of operation to another, conductive rod 510 rotates 180° to exchange the cathodes of each pair. Throughout both phases of operation, the bioanodes 508 are interleaved between the cathodes remain submerged and fixed in position. In the configuration of FIG. 5D, a rack of cathode disks 512 are mounted on a conductive rod 516 such that a portion of the disk is submerged and another portion of the disk is exposed to air. The rod rotates either continuously or intermittently to submerge a new portion of the cathode disks while exposing a new portion on the opposite side of the disk. The bioanodes 514 are interleaved between the cathodes and remain submerged and fixed in position during operation.

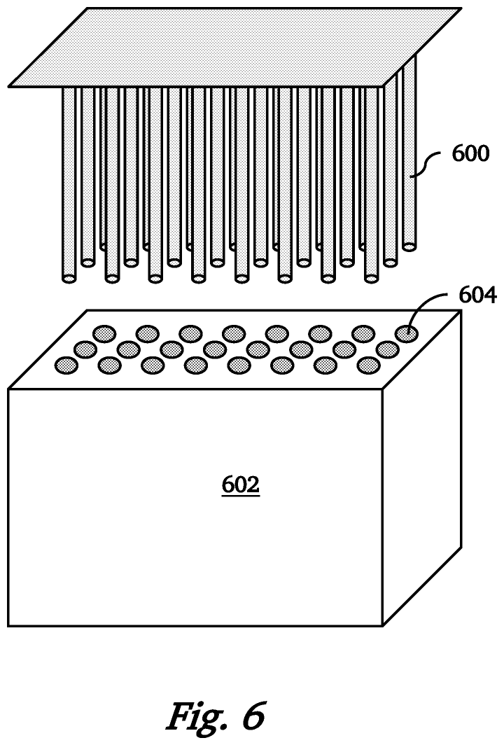

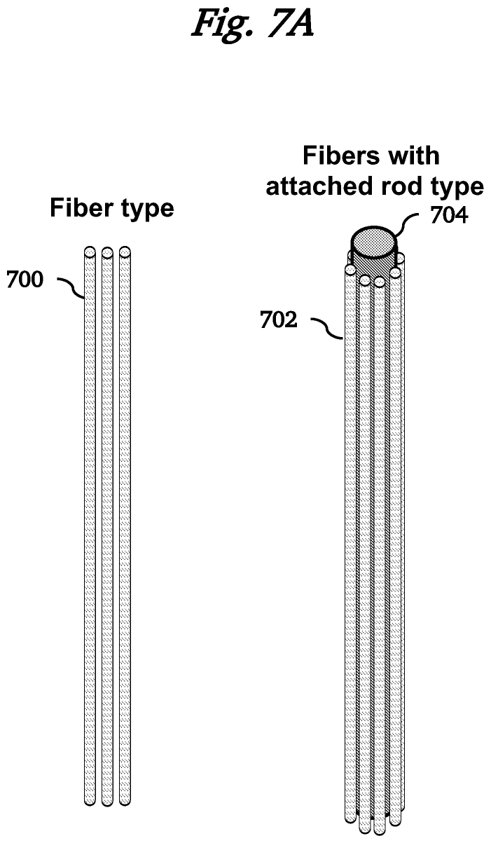

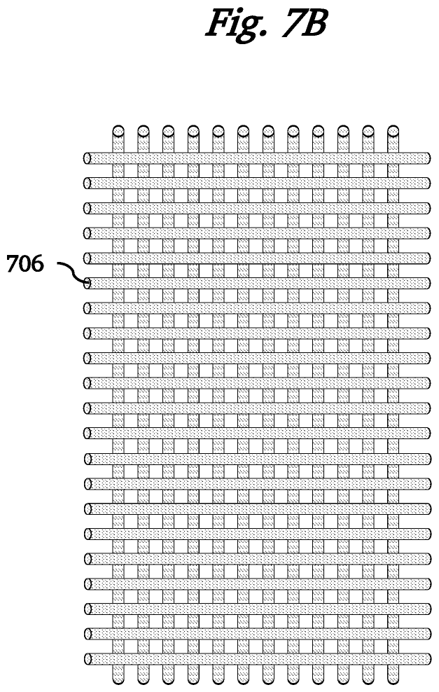

Although the electrodes in the embodiments described above are shaped as plates, the electrodes may have a variety of others shapes. FIG. 6 shows cathodes 600 shaped as columns (with circular or polygonal cross-section) that move in and out of a bioanode 602 having bioanode shafts 604 shaped similarly to the cathode rods so that their surfaces are in close proximity when the rods are inserted into the shafts. In other embodiments, as illustrated in FIG. 7A, the electrodes may be bioinspired conductive fibers 700, or fibers 702 attached to and surrounding a larger central rod 704. These rods and/or fibers are used as cathodes that move in and out of shafts, as shown in FIG. 6. In other embodiments, as illustrated in FIG. 7B, the electrodes may be conductive fibers 706 (e.g., carbon fiber) arranged in a mesh to form plate-shaped electrodes. The electrodes may also be a sponge-like material with conductive current collectors.

Other than the bioinspired fibers and the mesh materials, porous and conductive sponge-like materials (e.g., carbon nanotube sponge or activated carbon sponge) can be used for the electrodes to maximize specific surface area. Current collectors (e.g., stainless steel) can be embedded within the conductive electrodes.

Returning to FIG. 3, the membrane module 304 includes membranes 326 that retain particulate organic matter within the system, ensuring their efficient hydrolysis by extracellular enzymes and yielding soluble substrate that is oxidized by exoelectrogens within the bioanodes, ultimately producing a particle-free clean effluent.

The membranes 326 are preferably hollow fiber ultrafiltration membranes with membrane pore sizes ranging from 0.01 to 0.07 μm. Air-diffusers 328 positioned at the bottom of the membrane module provide energy-efficient fouling control while minimizing chemical requirements for cleaning. Aerobic biomass growing near the membrane modules ensures removal of organic matter to low levels within the permeate effluent and also prevents dissolved O₂ from diffusing into the microbial battery.

To control membrane fouling, the membranes may be sparged with gas through a blower and diffuser 328 (0.05˜0.3 Nm³/m²/h gas sparing intensity per membrane surface). If the sparge gas includes any oxygen (e.g., air), aerobic heterotrophic bacteria can grow, outcompeting exoelectrogens for electron donors, and the membrane modules should therefore be ideally placed in a chamber that is separated from the bioanode. In one embodiment, this could be accomplished by placement of a baffle 310 that prevents incidental oxygen delivery to the microbial battery unit. Control of membrane fouling can be accomplished by periodic relaxations (20% of operation time, e.g., 8 minutes on/2 minutes off), backwashing, and chemical cleanings. Preferably, there is minimal air sparing in the membrane zone, enabling membrane scouring for fouling controls better effluent quality (bio-flocculation for UFCOD).

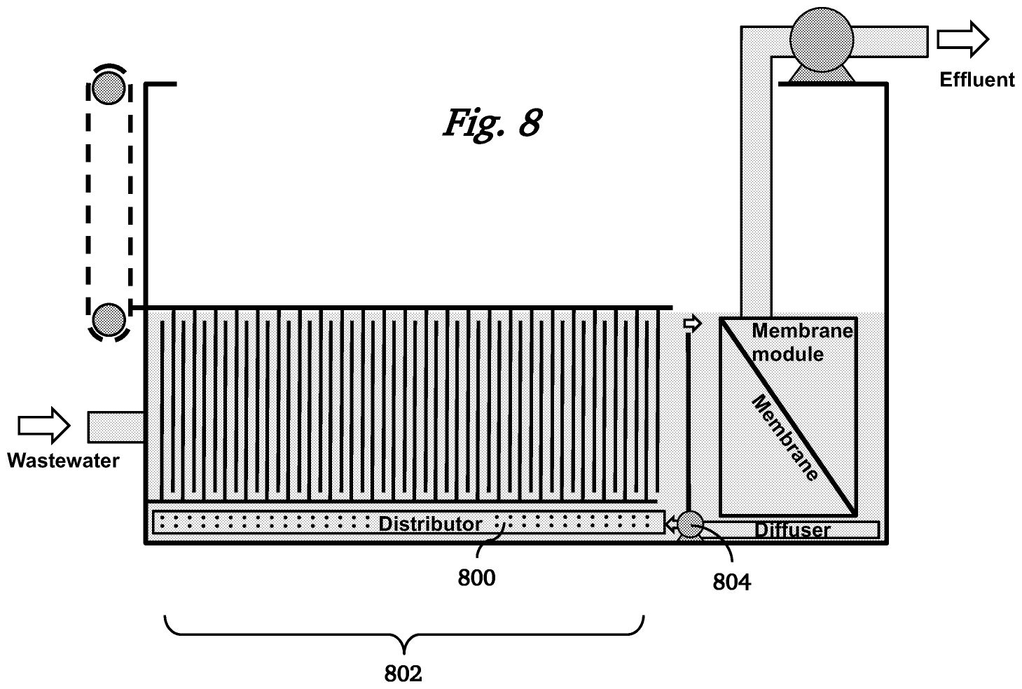

In another embodiment, shown in FIG. 8, a distributor 800 is positioned beneath the electrodes at the bottom of the microbial battery compartment 802. The distributor 800 is connected to the outlet of the pump 804 and may be implemented as a tube with many small holes positioned along its length. Fluid pumped into the microbial battery compartment from the membrane compartment flows into one end of the distributor 800 and exits the distributor 800 through the small holes along its length, thereby facilitating even distribution of the fluid within the microbial battery compartment.

1. A microbial battery membrane bioreactor comprising:
a reactor chamber adapted to hold wastewater at a liquid level;
a wastewater inlet to the reactor chamber;
a membrane module positioned within the reactor chamber below the liquid level and adapted to provide ultrafiltration of the wastewater;
an effluent outlet from the membrane module;
a collection of bioanodes fixed in a position within the reactor chamber below the liquid level;
a collection of cathodes vertically movable between a first position within the reactor chamber below the liquid level and a second position above the liquid level; wherein the bioanodes and cathodes are paired with a bioanode-cathode surface separation less than 5 cm when the cathodes are in the first position;
and
a motor adapted to move the cathodes vertically.

2. The microbial battery membrane bioreactor of claim 1 wherein the bioanodes and cathodes comprise paired parallel plates.

3. The microbial battery membrane bioreactor of claim 1 wherein the motor is adapted to rotate the paired parallel plates of the cathodes, or linearly raise and lower the paired parallel plates of the cathodes.

4. The microbial battery membrane bioreactor of claim 1 wherein the bioanodes comprise rods, fibers, fibers with attached rods, or a conductive mesh.

5. The microbial battery membrane bioreactor of claim 1 wherein the cathodes comprise rods, fibers, fibers with attached rods, or a conductive mesh.

6. The microbial battery membrane bioreactor of claim 5 wherein the rods have a circular, rectangular, triangular, or hexagonal cross-sectional shape.

7. The microbial battery membrane bioreactor of claim 1 wherein the cathodes and the bioanodes are not separated by any membrane in the reactor chamber.

8. The microbial battery membrane bioreactor of claim 1 wherein the cathodes and the bioanodes are not separated by a proton-exchange membrane.

9. The microbial battery membrane bioreactor of claim 1 wherein the bioanodes are composed of graphene or conductive activated carbon-based materials.

10. The microbial battery membrane bioreactor of claim 1 wherein the cathodes are composed of Prussian Blue attached to a conductive structure or a second conductive material enabling cation diffusion into and out of the electrode.

11. The microbial battery membrane bioreactor of claim 1 wherein the membrane module comprises hollow fiber ultrafiltration membranes with membrane pore diameters in the range 0.01 to 0.07 μm.

12. The microbial battery membrane bioreactor of claim 1 wherein the membrane module incorporates gas diffusers.

13. The microbial battery membrane bioreactor of claim 1 wherein the cathodes are arranged to move vertically together in a single set.

14. The microbial battery membrane bioreactor of claim 1 wherein the cathodes are divided into two sets, wherein the sets are configured to move vertically in opposite directions.

15. The microbial battery membrane bioreactor of claim 1 wherein the membrane module is separated from the cathodes and bioanodes by a physical wall adapted to prevent short-circuiting of fluid flow around the cathodes and bioanodes or incidental delivery of oxygen to the bioanode.

16. The microbial battery membrane bioreactor of claim 15 further comprising a recirculation pump adapted to send bulk solution through the physical wall, providing more contact time for hydrolysis of complex organic matter.

17. The microbial battery membrane bioreactor of claim 16 further comprising a distributor connected to the recirculation pump and positioned below the cathodes and bioanodes to enable even distribution of complex organic matter.

18. The microbial battery membrane bioreactor of claim 1 wherein the membrane module includes a wasting outlet to control solids residence time within the reactor.

19. The microbial battery membrane bioreactor of claim 1 wherein the bioreactor is configured to maintain and control the liquid level at a constant level.

20. A method for bioelectrochemical wastewater treatment comprising:
injecting wastewater into a microbial battery comprising bioanodes and cathodes,
wherein the bioanodes are coated with exoelectrogen and wherein the cathodes are solid state cathodes;
circulating the wastewater between the microbial battery and a membrane module that retains particulate organic matter;
periodically moving the cathodes vertically between a first position and a second position,
wherein the cathodes in the first position are oxidized by exposure to oxygen in air;
wherein the cathodes in the second position oxidize soluble compounds in the wastewater, releasing electrons to the cathodes;
wherein the cathodes in the second position have less than 5 cm separation from the bioanodes;
and
recovering treated effluent from the membrane module.

21. The method of claim 20 wherein the cathodes in the first position are entirely above a surface level of the wastewater; and wherein the cathodes in the second position are submerged entirely below the surface level of the wastewater.

22. The method of claim 20 further comprising: performing fouling control of membranes in the membrane module using gas-diffusers.

23. The method of claim 20 further comprising: performing hydrolysis facilitating even distribution of complex organic matter using a distributor positioned below the cathodes and bioanodes.

24. The method of claim 20 further comprising: performing post treatment to the treated effluent using a primary clarifier or microscreen.
